(19) United States
(12) Patent Application Publication
(10) Pub. No.: US 2025/0368102 A1
(43) Pub. Date: Dec. 4, 2025

(54) VEHICLE CONTROL APPARATUS AND METHOD THEREOF

(71) Applicants: Hyundai Motor Company, Seoul (KR); Kia Corporation, Seoul (KR)

(72) Inventors: Ji Su Kim, Hwaseong-Si (KR); Kung Hun Han, Hwaseong-si (KR)

(21) Appl. No.: 18/937,211

(22) Filed: Nov. 5, 2024

(30) Foreign Application Priority Data
May 28, 2024 (KR) 10-2024-0069456

(51) Int. Cl. B60N 2/56; B60R 21/015

(52) U.S. Cl. CPC B60N 2/5621; B60R 21/01512

(57) ABSTRACT

An apparatus for controlling a vehicle is introduced. The apparatus may comprise a memory storing at least one instruction, and a processor, wherein the at least one instruction is configured to, when executed by the processor, cause the apparatus to turn on, based on an occurrence of a specified event, an air conditioning function, of an air conditioner, for a specified seat, determine, based on sensor information from a sensor, whether a user is sitting on the specified seat, and determine, based on the user sitting on the specified seat, whether to turn off the air conditioning function, based on at least one of a type of the specified seat, whether a no sitting state of the user is determined, a duration of the no sitting state, a speed of the vehicle, or whether a door corresponding to the specified seat is open.

### CROSS-REFERENCE TO RELATED APPLICATION

This application claims the benefit of priority to Korean Patent Application No. 10-2024-0069456, filed in the Korean Intellectual Property Office on May 28, 2024, the entire contents of which are incorporated herein by reference.

### TECHNICAL FIELD

The present disclosure relates to a vehicle control apparatus and a method thereof, and more particularly, relates to technologies for performing an air conditioning function for a seat and adaptively controlling an operation of the air conditioning function depending on whether a specified condition is met.

### BACKGROUND

The matters described in this Background section are only for enhancement of understanding of the background of the disclosure, and should not be taken as acknowledgement that they correspond to prior art already known to those skilled in the art.

With the development of technology, various components may be operatively connected with each other in a vehicle. Particularly, a vehicle control apparatus may perform cooperative control between the components for convenience of a user, thus quickly and accurately providing various functions.

A plurality of seats may be mounted inside a host vehicle. In addition or alternative, an air conditioner provided to provide a user who is sitting on the seat with an optimal indoor environment may be mounted on each of the plurality of seats. For example, the air conditioner may include at least one of a heating wire device for providing a specified area of the seat with a heating function or a ventilation device for providing a cool breeze, or any combination thereof.

Meanwhile, if the user requests to operate an air conditioning function for a specified seat (or if the vehicle control apparatus identifies a user input (e.g., a button input, a voice input, or a touch input)) for the specified seat, the vehicle control apparatus may perform the air conditioning function via the specified seat. At this time, after the air conditioning function operates, if the user which is sitting on the specified seat moves to another seat or deviates from the host vehicle, the unnecessary air conditioning function continues being performed to waste power.

In other words, although there occurs a situation in which there is no need to perform the air conditioning function for the specified seat, the vehicle control apparatus does not currently provide a function of ending the air conditioning function by means of adaptive cooperation with an air conditioning device.

### SUMMARY

According to the present disclosure, an apparatus for controlling a vehicle, the apparatus may comprise a sensor, an air conditioner, a memory storing at least one instruction, and a processor operatively coupled to the sensor, the air conditioner, and the memory, wherein the at least one instruction is configured to, when executed by the processor, cause the apparatus to turn on, based on an occurrence of a specified event, an air conditioning function, of the air conditioner, for a specified seat, determine, based on sensor information from the sensor, whether a user is sitting on the specified seat, and determine, based on a determination that the user is sitting on the specified seat, whether to turn off the air conditioning function, based on at least one of a type of the specified seat, whether a no sitting state of the user is determined, a duration of the no sitting state, a speed of the vehicle, or whether a door corresponding to the specified seat is open.

The apparatus may further comprise a user interface configured to receive at least one user input, wherein the at least one instruction is configured to, when executed by the processor, cause the apparatus to, based on receiving, via the user input, a user input associated with the air conditioning function for the specified seat, determine that the specified event occurs.

The apparatus, wherein the at least one instruction is configured to, when executed by the processor, cause the apparatus to turn off, based on elapsing of a specified time and the specified seat may comprise a child seat, the air conditioning function for the specified seat.

The apparatus, wherein the at least one instruction is configured to, when executed by the processor, cause the apparatus to, after the determination that the user is sitting on the specified seat, determine, based on sensor information from the sensor, a state of the user as the no sitting state, wherein the no sitting state indicates that the user is not sitting on the specified seat, monitor the duration of the no sitting state, and turn off, based on the duration satisfying a threshold, the air conditioning function for the specified seat.

The apparatus, wherein the at least one instruction is configured to, when executed by the processor, cause the apparatus to, after the determination that the user is sitting on the specified seat, determine, based on sensor information from the sensor, a state of the user as the no sitting state, wherein the no sitting state indicates that the user is not sitting on the specified seat, monitor, based on the determination of the no sitting state, the speed of the vehicle, and turn off, based on the speed of the vehicle satisfying a threshold speed, the air conditioning function for the specified seat.

The apparatus, wherein the at least one instruction is configured to, when executed by the processor, cause the apparatus to, after the determination that the user is sitting on the specified seat, determine, based on sensor information from the sensor, a state of the user as the no sitting state, wherein the no sitting state indicates that the user is not sitting on the specified seat, monitor, based on the determination of the no sitting state and the door corresponding to the specified seat being closed and then opened, the duration of the no sitting state, and turn off, based on the duration satisfying a threshold, the air conditioning function for the specified seat.

The apparatus, wherein the at least one instruction is configured to, when executed by the processor, cause the apparatus to, after the determination that the user is sitting on the specified seat, determine, based on sensor information from the sensor, a state of the user as the no sitting state, wherein the no sitting state indicates that the user is not sitting on the specified seat, determine, based on the determination of the no sitting state and the door corresponding to the specified seat being closed and then opened, the speed of the vehicle, and turn off, based on the speed of the vehicle satisfying a threshold speed, the air conditioning function for the specified seat.

The apparatus, wherein the air conditioning function may comprise a heating wire function for the specified seat and a ventilation function for the specified seat.

The apparatus, wherein the at least one instruction is configured to, when executed by the processor, cause the apparatus to, after the determination that the user is sitting on the specified seat, determine a state of the user as the no sitting state, wherein the no sitting state indicates that the user is not sitting on the specified seat, and maintain, based on the determination of the no sitting state and a reoccurrence of the specified event within a threshold time, the air conditioning function, wherein the air conditioning function is maintained based on a minimum operable intensity.

The apparatus, wherein the at least one instruction is configured to, when executed by the processor, cause the apparatus to, after the determination that the user is sitting on the specified seat, determine a state of the user as the no sitting state and that the vehicle is stopped, wherein the no sitting state indicates that the user is not sitting on the specified seat, and maintain, based on the determination of the no sitting state and the vehicle being stopped, the air conditioning function, wherein the air conditioning function is maintained based on a minimum operable intensity.

According to the present disclosure, a method performed by an apparatus for controlling a vehicle, the method may comprise turning on, based on an occurrence of a specified event, an air conditioning function, of an air conditioner, for a specified seat, determining, based on sensor information from a sensor, whether a user is sitting on the specified seat, and determining, based on a determination that the user is sitting on the specified seat, whether to turn off the air conditioning function, based on at least one of a type of the specified seat, whether a no sitting state of the user is determined, a duration of the no sitting state, a speed of the vehicle, or whether a door corresponding to the specified seat is open.

The method may further comprise based on receiving, via a user interface of the apparatus, a user input associated with the air conditioning function for the specified seat, determining that the specified event occurs.

The method may further comprise turning off, based on elapsing of a specified time and the specified seat may comprise a child seat, the air conditioning function for the specified seat.

The method may further comprise after the determination that the user is sitting on the specified seat determining, based on sensor information from the sensor, a state of the user as the no sitting state, wherein the no sitting state indicates that the user is not sitting on the specified seat, monitoring the duration of the no sitting state, and turning off, based on the duration satisfying a threshold, the air conditioning function for the specified seat.

The method may further comprise after the determination that the user is sitting on the specified seat determining, based on sensor information from the sensor, a state of the user as the no sitting state, wherein the no sitting state indicates that the user is not sitting on the specified seat, monitoring, based on the determining the no sitting state, the speed of the vehicle, and turning off, based on the speed of the vehicle satisfying a threshold speed, the air conditioning function for the specified seat.

The method may further comprise after the determination that the user is sitting on the specified seat determining, based on sensor information from the sensor, a state of the user as the no sitting state, wherein the no sitting state indicates that the user is not sitting on the specified seat, monitoring, based on the determining the no sitting state and the door corresponding to the specified seat being closed and then opened, the duration of the no sitting state, and turning off, based on the duration satisfying a threshold, the air conditioning function for the specified seat.

The method may further comprise after the determination that the user is sitting on the specified seat determining, based on sensor information from the sensor, a state of the user as the no sitting state, wherein the no sitting state indicates that the user is not sitting on the specified seat, determining, based on the determining the no sitting state and the door corresponding to the specified seat being closed and then opened, the speed of the vehicle, and turning off, based on the speed of the vehicle satisfying a threshold speed, the air conditioning function for the specified seat.

The method, wherein the air conditioning function may comprise a heating wire function for the specified seat and a ventilation function for the specified seat.

The method may further comprise after the determination that the user is sitting on the specified seat determining a state of the user as the no sitting state, wherein the no sitting state indicates that the user is not sitting on the specified seat, and maintaining, based on the determining the no sitting state and a reoccurrence of the specified event within a threshold time, the air conditioning function, wherein the air conditioning function is maintained based on a minimum operable intensity.

The method may further comprise after the determination that the user is sitting on the specified seat determining a state of the user as the no sitting state and that the vehicle is stopped, wherein the no sitting state indicates that the user is not sitting on the specified seat, and maintaining, based on the determining the no sitting state and the vehicle being stopped, the air conditioning function, wherein the air conditioning function is maintained based on a minimum operable intensity.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of components of a vehicle control apparatus according to an example of the present disclosure;

FIG. 2 shows an example of components of a vehicle control apparatus according to an example of the present disclosure;

FIG. 3 shows an example of a vehicle control method according to an example of the present disclosure;

FIG. 4 shows an example of a vehicle control method according to an example of the present disclosure; and

FIG. 5 shows an example of a computing system about a vehicle control apparatus or a vehicle control method according to an example of the present disclosure.

With regard to description of drawings, the same or similar denotations may be used for the same or similar components.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing the components of the example of the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

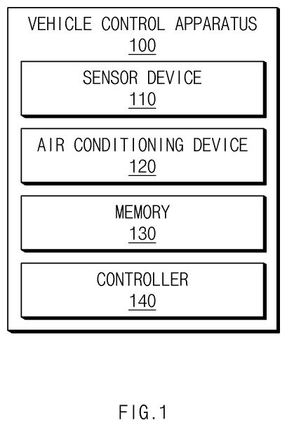

Hereinafter, examples of the present disclosure will be described in detail with reference to FIGS. 1 to 5.

FIG. 1 shows an example of components of a vehicle control apparatus according to an example of the present disclosure.

According to an example, a vehicle control apparatus 100 may include at least one of a sensor device 110, an air conditioning device 120, a memory 130, or a controller 140, or any combination thereof. The components of the vehicle control apparatus 100, which are shown in FIG. 1, are illustrative, and examples of the present disclosure are not limited thereto. For example, the vehicle control apparatus 100 may further include components (e.g., at least one of an input device, an interface, a communication device, a notification device, or a driving device, or any combination thereof) which are not shown in FIG. 1.

According to an example, the sensor device 110 may include at least one sensor for obtaining (or identifying) various pieces of information about a driving state of a host vehicle, a state of a seat, and/or a component (e.g., a door) mounted on the host vehicle.

For example, the sensor device 110 may obtain the information about the driving state of the host vehicle. The information about the driving state may include, for example, a real-time operation state of the host vehicle (e.g., whether the host vehicle is during manual driving or autonomous driving), information about an operation (or driving) history of the host vehicle, or a speed (or a driving speed) of the host vehicle. Further, for example, the information about the driving state of the host vehicle may include the current gear position, throttle position, brake status, steering angle, acceleration and deceleration rates, tire pressure levels, fuel level or battery charge status, engine RPM, lane position, turn signal status, windshield wiper activation status, cruise control or adaptive cruise control status, distance to the leading vehicle, environmental factors such as outside temperature and road conditions, stability control system activation, collision avoidance system status, GPS location, yaw rate, vehicle weight distribution, or passenger presence detection, etc.

For example, the sensor device 110 may obtain the various pieces of information about the component (e.g., the door) mounted on the host vehicle. For example, the various pieces of information may include the window position, lock status, trunk or hatch status, sunroof or moonroof position, side mirror adjustment position, seatbelt engagement status, fuel door position, hood status, seat position, heated seat activation status, child lock activation, interior lighting status, door seal integrity, tire pressure monitoring system status for individual tires, power seat adjustment status, airbag deployment readiness, windshield washer fluid level, side step or running board position, camera system status, or exterior lighting status. As an example, the sensor device 110 may identify an opening and closing state of a door. As an example, the sensor device 110 may identify a state (e.g., an opening and closing state) of each door mounted on the host vehicle, based on various signal processing systems (e.g., a controller area network (CAN) bus, a pulse width modulation (PWM) signal system, or the like).

For example, the sensor device 110 may include at least one of a passenger sensor (e.g., a pressure sensor, a camera, or the like), a buckle sensor, a seat belt reminder (SBR) sensor, or a rear occupant alarm (ROA) system, or any combination thereof.

As an example, the sensor device 110 may identify whether a user is riding in a seat (or sitting on the seat), using at least some of the above-mentioned sensors. For example, if sensing that a buckle is fastened using the buckle sensor and/or the SBR sensor, the sensor device 110 may identify that the passenger sits on the seat.

As an example, the sensor device 110 may identify whether the user is riding in any seat. As an example, if the user deviates from the seat in which he or she is riding, the sensor device 110 may identify that the seat is in a no sitting state. As an example, the sensor device 110 may monitor a duration of the no sitting state of the seat. The controller 140 may identify, for example, whether the user is riding in each of seats included in the host vehicle, in real time using at least one sensor.

According to an example, the air conditioning device 120 may include at least one air conditioner for performing various types of air conditioning functions for the interior of the host vehicle.

For example, the air conditioning device 120 may include a plurality of heating wire devices for performing a heating wire function for each of the plurality of seats and a plurality of ventilation devices for performing a ventilation function. Additionally or alternatively, the air conditioning device 120 may comprise automatic climate control, dual-zone or multi-zone climate control, humidity control, air filtration and purification, defogging and defrosting, recirculation mode, automatic fan speed adjustment, rear seat climate control, heated steering wheel functionality, heated or cooled cupholders, UV protection or filtering, pre-conditioning of the cabin, ambient air scenting, noise reduction via acoustic air channels, or seat cooling.

For example, the ventilation device included in the air conditioning device 120 may include a small fan in the seat.

For example, the heating wire device included in the air conditioning device 120 may include a thermoelectric element (e.g., a thermoelectric device (TED)).

For example, if a user input for requesting to activate the air conditioning function for a specified seat is received, the controller 140 may activate the air conditioning function (e.g., the heating wire function or the ventilation function) for the specified seat corresponding to the user input, using at least one of the plurality of air conditioners included in the air conditioning device 120.

According to an example, the memory 130 may store a command or data. For example, the memory 130 may store one or more instructions, when executed by the controller 140, causing the vehicle control apparatus 100 to perform various operations.

For example, the memory 130 and the controller 140 may be implemented as one chipset. The controller 140 may include at least one of a communication processor or a modem.

According to an example, the controller 140 may be operatively connected with at least one of the sensor device 110, the air conditioning device 120, or the memory 130, or a combination thereof. For example, the controller 140 may control an operation of at least one of the sensor device 110, the air conditioning device 120, or the memory 130, or a combination thereof.

For example, if identifying that a specified event occurs, the controller 140 may turn on the air conditioning function for the specified seat, using the air conditioning device 120.

As an example, if receiving a user input via an input device (not shown), the controller 140 may identify that the specified event occurs. The user input (e.g., a pressure input, a touch input, and/or a voice input) may be obtained via, for example, the input device about the air conditioning function for the specified seat. The input device may include at least one of, for example, a button, a touch screen, or a microphone, or any combination thereof.

For example, the controller 140 may turn on the air conditioning function based on that the specified event occurs and may identify whether the user is sitting on the specified seat using the sensor device 110. For example, the controller 140 may determine whether the air conditioning function is the heating wire function or the ventilation function, using an input type, an input position, an input scheme, or the like of the user input, and may turn on the determined air conditioning function.

For example, if it is identified that the user is not sitting on the specified seat, the controller 140 may set operation intensity of the air conditioning function for the specified seat to predefined intensity (e.g., minimum operable intensity) and may operate the air conditioning function, after a predefined time elapses from a time point if it is identified that the user is not sitting on the specified seat. The predefined time and the predefined intensity may be, for example, setting values changeable by settings of a developer and/or the user.

For example, if it is identified that the user is sitting on the specified seat, the controller 140 may determine whether to turn off the air conditioning function, based on at least one of a type of the specified seat, whether the no sitting state of the user is identified, a duration of the no sitting state, a speed of the host vehicle, or whether a door corresponding to the specified seat is open, or any combination thereof.

As an example, if the specified seat includes a child seat, the controller 140 may turn off the air conditioning function for the specified seat if the specified time elapses. For example, if identifying that the child seat is placed on the specified seat, the controller 140 may turn off the air conditioning function for the specified seat, after the specified time elapses from a time point if the child seat is identified. The specified time may be, for example, a setting value changeable by settings of the developer and/or the user.

After it is identified that the user is sitting, the controller 140 may identify the no sitting state for the specified seat, using the sensor device 110. As an example, the controller 140 may monitor that the user who is sitting on the specified seat deviates from the specified seat, using the sensor device 110. In this case, the controller 140 may determine that the no sitting state starts. As an example, the controller 140 may monitor a duration if the no sitting state is maintained.

As an example, if the duration of the no sitting state is greater than a threshold, the controller 140 may turn off the air conditioning function for the specified seat. In this case, the controller 140 may turn off the air conditioning function as soon as it is determined that the duration of the no sitting state is greater than the threshold and may turn off the air conditioning function for the specified seat after a specific time elapses from the time point if it is determined that the duration is greater than the threshold. For example, a holding time (e.g., the specific time) for turning off the air conditioning function may be a setting value changeable by settings of the developer and/or the user.

As an example, after the no sitting state is identified, the controller 140 may monitor a speed of the host vehicle, using the sensor device 110. For example, if the speed of the host vehicle is greater than a threshold speed, the controller function for the 140 may turn off the air conditioning specified seat.

As an example, after the no sitting state is identified, the controller 140 may identify a state of a door corresponding to the specified seat, using the sensor device 110. The state of the door may include, for example, a real-time opening and closing state of the door. The door may be, for example, a door which is most adjacent to the specified seat. For example, if it is identified that the door is closed and then opened (or if it is identified that the door is closed and opened and is then closed again), the controller 140 may monitor the duration of the no sitting state. If the duration is greater than the threshold, the controller 140 may turn off the air conditioning function for the specified seat. In other words, if the door is closed and then opened in the state in which the no sitting state is identified and the duration of the no sitting state is greater than the threshold, the controller 140 may determine that the user who is sitting on the specified seat deviates from the specified seat and may turn off the air conditioning function.

As an example, after the no sitting state is identified, the controller 140 may identify the state of the door corresponding to the specified seat, using the sensor device 110. For example, if it is identified that the door is closed and then opened (or if it is identified that the door is closed and opened and is then closed again), the controller 140 may identify (or monitor) a speed of the host vehicle. If the speed of the host vehicle is greater than the threshold speed, the controller 140 may turn off the air conditioning function for the specified seat. In other words, if the door is closed and then opened in the state in which the no sitting state is identified and the speed of the host vehicle is greater than the threshold speed (e.g., 3 km/h), the controller 140 may determine that driving of the host vehicle starts after the user who is sitting on the specified seat deviates from the specified seat and may turn off the air conditioning function.

For example, the threshold and/or the threshold speed may be setting values changeable by settings of the developer and/or the user. For example, as the user changes a user setting about turning on/off the air conditioning function, although the above-mentioned conditions are met, the vehicle control apparatus 100 may fail to turn off the air conditioning function.

For example, the controller 140 may control the air conditioning function in another scheme except for turning off the air conditioning function based on at least some of the above-mentioned examples. As an example, if an air conditioning function off condition is met according to at least some of the above-mentioned examples, the controller 140 may operate the air conditioning function based on minimum operable intensity during a first time without immediately turning off the air conditioning function. As an example, if the air conditioning function off condition is continuously met although the first time elapses, the controller 140 may turn off the air conditioning function. For examples, the minimum operable intensity for the air conditioning function may comprise setting the fan speed to low, regulating the temperature slightly higher to reduce compressor load, cycling the compressor at longer intervals, switching to ventilation-only mode without cooling, focusing cooling on occupied seats while for unoccupied areas, and maintaining minimal intensity reducing blower speed to a trickle for unoccupied zones.

For example, after it is identified that the user is sitting, if identifying that the specified event occurs again within the threshold time (e.g., 1 minute) in the situation in which no sitting state is identified, the controller 140 may maintain (or operate) the air conditioning function during the first time based on the minimum operable intensity. This case may be a situation in which the user requests to remotely operate the air conditioning function in advance outside the host vehicle, before he or she rides in the host vehicle after deviating from the host vehicle in the situation in which the air conditioning function is turned on. Thus, although the user is not sitting, the controller 140 may operate the air conditioning function in advance at minimum intensity during the first time. If the user does not sit on the seat although the first time elapses, the controller 140 may turn off the air conditioning function.

For example, after it is identified that the user is sitting on the seat, if the no sitting state and the state in which the host vehicle is being stopped are identified, the controller 140 may maintain (or operate) the air conditioning function during the first time based on the minimum operable intensity. This case may be a situation in which the host vehicle is being stopped after the user deviates from the host vehicle in the situation in which the air conditioning function is turned on. Thus, although the user is not sitting, because the host vehicle is being stopped, the controller 140 may determine that the user will return to the host vehicle again and may operate the air conditioning function in advance at the minimum intensity during the first time.

The components of the vehicle control apparatus 100, which are shown in FIG. 1, are illustrative, and examples of the present disclosure are not limited thereto. For example, the vehicle control apparatus 100 may further include at least one of an input device, a switch, an output device, a communication device, or an interface, or any combination thereof.

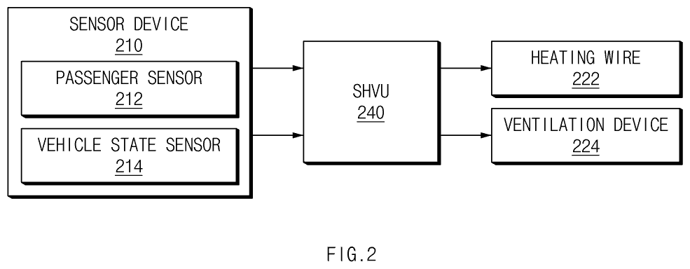

FIG. 2 shows an example of components of a vehicle control apparatus according to an example of the present disclosure.

According to an example, a vehicle control apparatus (e.g., a vehicle control apparatus 100 of FIG. 1) may include a sensor device 210 (e.g., a sensor device 110 of FIG. 1), a seat heating ventilation unit (SHVU) 240 (e.g., a controller 140 of FIG. 1), a heating wire device 222, and/or a ventilation device 224.

For example, the sensor device 210 may include passenger sensor 212 and a vehicle state sensor 214.

For example, the heating wire device 222 and the ventilation device 224 are shown as independently divided components, but may be integrated and implemented into one device (e.g., an air conditioning device 120 of FIG. 1).

For example, the vehicle control apparatus may determine whether an operation condition for turning off an air conditioning function is met, using the sensor device 210.

As an example, the vehicle control apparatus may monitor whether a user is sitting on a seat in real time, using the passenger sensor 212.

As an example, the vehicle control apparatus may monitor at least one of a speed of a host vehicle, an opening and closing state of a door, or a type of the seat, or any combination thereof, using the vehicle state sensor 214.

As an example, the vehicle control apparatus may process at least some of the pieces of information obtained using the sensor device 210, by means of the SHVU 240.

For example, the SHVU 240 may turn on the heating wire device 222 and/or the ventilation device 224 based on that a specified event occurs. The heating wire device 222 and/or the ventilation device 224 may be, for example, an air conditioning device for performing a heating wire function and/or a ventilation function for a specified seat.

As an example, after performing the air conditioning function for the specified seat, the SHVU 240 may turn off (or deactivate) the air conditioning function and/or may determine whether a condition for reducing operation intensity of the air conditioning function is met, based on the information obtained by means of the sensor device 210.

As an example, if identifying that the user is not sitting on the specified seat, the SHVU 240 may set operation intensity of the air conditioning function for the specified seat to minimum intensity.

As an example, if the specified seat includes a child seat (or if the child seat is mounted on a sitting area of the specified seat), the SHVU 240 may turn off the air conditioning function for the specified seat.

As an example, if identifying that the user deviates from the specified seat while sitting on the specified seat, the SHVU 240 may turn off the air conditioning function, if the duration of the deviation (or no sitting) state is greater than a threshold or the speed of the host vehicle is greater than a threshold speed.

As an example, after identifying that the user deviates from the specified seat while sitting on the specified seat, if identifying that a door corresponding to the specified seat is closed and then opened, the SHVU 240 may turn off the air conditioning function.

As an example, after identifying that the user deviates from the specified seat while sitting on the specified seat, if identifying that the speed of the host vehicle is greater than the threshold speed, the SHVU 240 may turn off the air conditioning function.

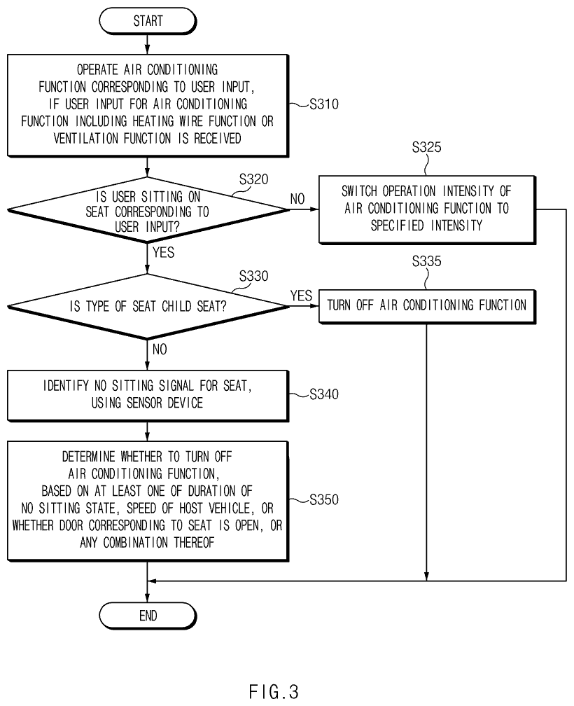

FIG. 3 shows an example of a vehicle control method according to an example of the present disclosure.

According to an example, a vehicle control apparatus (e.g., a vehicle control apparatus 100 of FIG. 1) may perform operations disclosed in FIG. 3. For example, at least some of components (e.g., a sensor device 110, an air conditioning device 120, a memory 130, and a controller 140 of FIG. 1) included in the vehicle control apparatus may be configured to perform the operations of FIG. 3. One, some, or all steps of the vehicle control method of FIG. 3, or portions thereof, may be performed by one or more other circuits. One or some, steps of the vehicle control method of FIG. 3 may be omitted, performed in other orders, and/or otherwise modified, and/or one or more additional steps may be added.

Operations in S310 to S350 in an example below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 3, may be briefly described or omitted.

According to an example, in S310, if a user input for an air conditioning function including a heating wire function or a ventilation function is received, the vehicle control apparatus may operate (or turn on) the air conditioning function corresponding to the user input.

For example, the vehicle control apparatus may provide the air conditioning function via a specified seat corresponding to the user input.

For example, the air conditioning function may include the heating wire function and/or the ventilation function via the specified seat.

According to an example, in S320, the vehicle control apparatus may determine whether a user is sitting on the seat corresponding to the user input.

For example, if the user is sitting on the specified seat (e.g., S320—YES), the vehicle control apparatus may perform S330.

For example, if the user is not sitting on the specified seat (e.g., S320—NO), the vehicle control apparatus may perform S325.

According to an example, in S325, the vehicle control apparatus may switch operation intensity of the air conditioning function to specified intensity.

For example, the vehicle control apparatus may switch the air conditioning function to minimum operable intensity to operate the air conditioning function, thus preventing power from being wasted due to activation of the air conditioning function via the specified seat on which the user is not sitting.

For example, after switching the operation intensity to the specified intensity, if identifying that the user is not sitting on the specified seat although a predetermined time elapses, the vehicle control apparatus may turn off the air conditioning function.

According to an example, in S330, the vehicle control apparatus may determine whether the type of the seat is a child seat.

For example, the vehicle control apparatus may determine whether the specified seat includes the child seat, using a sensor device.

For example, if the child seat is mounted on at least a portion of a sitting area of the specified seat, the vehicle control apparatus may determine that the type of the seat includes the child seat.

For example, if the type of the seat is the child seat (e.g., YES—S330), the vehicle control apparatus may perform S335.

For example, if the type of the seat is not the child seat (e.g., NO—S330), the vehicle control apparatus may perform S340.

According to an example, in S335, the vehicle control apparatus may turn off the air conditioning function.

For example, if the specified seat includes the child seat, the vehicle control apparatus may determine that there is no need to perform the air conditioning function for the specified seat and may turn off the air conditioning function immediately (or after the specified time elapses).

According to an example, in S340, the vehicle control apparatus may identify a no sitting signal for the seat, using the sensor device.

For example, the vehicle control apparatus may identify (or obtain) the no sitting signal generated as the user who is sitting on the seat deviates from the seat, using the sensor device.

According to an example, in S350, the vehicle control apparatus may determine whether to turn off the air conditioning function, based on at least one of a duration of a no sitting state, a speed of a host vehicle, or whether a door corresponding to the seat is open, or any combination thereof.

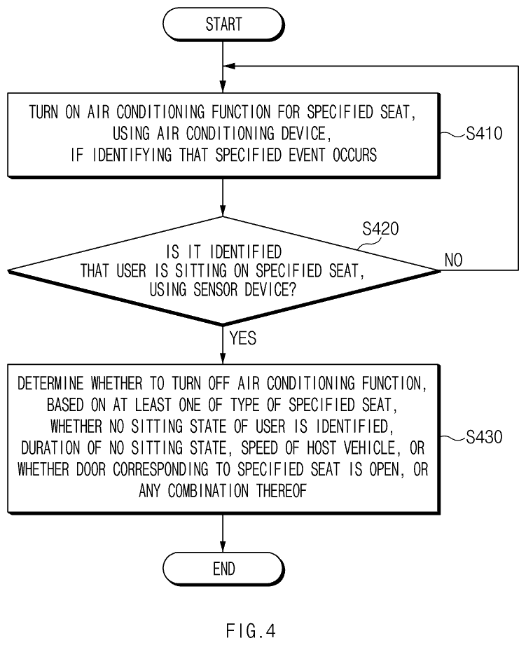

FIG. 4 shows an example of a vehicle control method according to an example of the present disclosure.

According to an example, a vehicle control apparatus (e.g., a vehicle control apparatus 100 of FIG. 1) may perform operations disclosed in FIG. 4. For example, at least some of components (e.g., a sensor device 110, an air conditioning device 120, a memory 130, and a controller 140 of FIG. 1) included in the vehicle control apparatus may be configured to perform the operations of FIG. 4. One, some, or all operations of FIG. 4, or portions thereof, may be performed by one or more other circuits. One or some, the operations of FIG. 4 may be omitted, performed in other orders, and/or otherwise modified, and/or one or more additional operations may be added.

Operations in S410 to S430 in an example below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 4, may be briefly described or omitted.

According to an example, in S410, the vehicle control apparatus may turn on an air conditioning function for a specified seat, using an air conditioning device, if identifying that a specified event occurs.

For example, if receiving a user input associated with the air conditioning function for the specified seat via an input device, the vehicle control apparatus may identify that the specified event occurs.

According to an example, in S420, the vehicle control apparatus may identify that a user is sitting on the specified seat, using a sensor device.

For example, if it is identified that the user is sitting on the specified seat (e.g., S420—YES), the vehicle control apparatus may perform S430.

For example, if it is identified that the user is not sitting on the specified seat (e.g., S420—NO), the vehicle control apparatus may repeatedly perform S410. For another example, if it is identified that the user is not sitting on the specified seat (e.g., S420—NO), the vehicle control apparatus may switch operation intensity of the air conditioning function to specified intensity (e.g., minimum operable intensity).

According to an example, in S430, the vehicle control apparatus may determine whether turn off the air conditioning function, based on at least one of a type of the specified seat (e.g., whether the specified seat includes a child seat), whether a no sitting state of the user is identified, a duration of the no sitting state, a speed of a host vehicle, or whether a door corresponding to the specified seat is open, or any combination thereof.

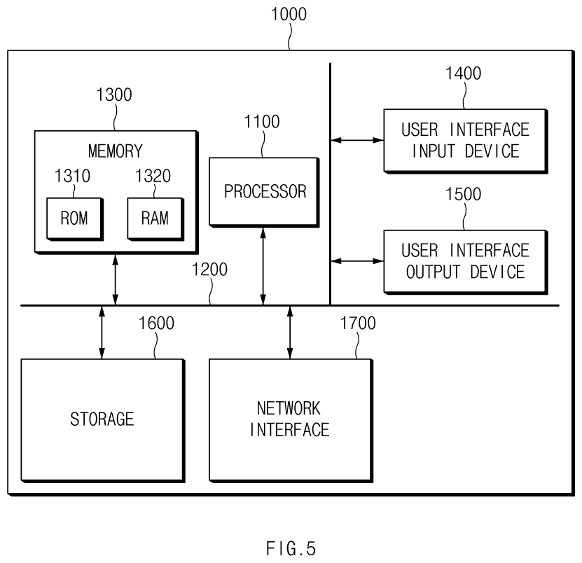

FIG. 5 shows an example of a computing system about a vehicle control apparatus or a vehicle control method according to an example of the present disclosure.

Referring to FIG. 5, a computing system 1000 about the vehicle control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present disclosure has been made to solve the above-mentioned problems occurring in the prior art while advantages achieved by the prior art are maintained intact.

An example of the present disclosure provides a vehicle control apparatus for adaptively terminating an air conditioning function which is being performed, if a situation in which it is okay even if the air conditioning function is terminated is identified, in the process in which the vehicle control apparatus performs the air conditioning function for a specified seat, to prevent unnecessary power consumption and a method thereof.

Another example of the present disclosure provides a vehicle control apparatus for first operating operation intensity of an air conditioning function as minimum intensity, if a user input about the air conditioning function is received in a situation in which the user is not sitting on the seat, to provide an efficient air conditioning function at the same time as matching the intention of a user (e.g., the intention of the user to activate the air conditioning function in advance before the user rides) and a method thereof.

Another example of the present disclosure provides a vehicle control apparatus for adaptively turning off an air conditioning function depending on whether a specified condition is met, in a situation in which it is difficult for a user to control whether to operate the air conditioning function for the specified seat (e.g., a situation in which it is difficult for the user to access an input device) and a method thereof.

Another example of the present disclosure provides a vehicle control apparatus for automatically turning off an air conditioning function a situation in which the air conditioning function does not need to operate to minimize unnecessary operation noise and provide a user with a pleasant indoor environment and a method thereof.

The technical problems to be solved by the present disclosure are not limited to the aforementioned problems, and any other technical problems not mentioned herein will be clearly understood the following description by those skilled in the art to which the present disclosure pertains.

According to an example of the present disclosure, a vehicle control apparatus may include a sensor device, an air conditioning device, a memory storing at least one instruction, and a controller operatively connected with the sensor device, the air conditioning device, and the memory. For example, the at least one instruction may, when executed by the controller, cause the vehicle control apparatus to turn on an air conditioning function for a specified seat using the air conditioning device, if identifying that a specified event occurs, identify whether a user is sitting on the specified seat, using the sensor device, and determine whether to turn off the air conditioning function, based on at least one of a type of the specified seat, whether a no sitting state of the user is identified, a duration of the no sitting state, a speed of a host vehicle, or whether a door corresponding to the specified seat is open, or any combination thereof, if it is identified that the user is sitting.

According to an example, the vehicle control apparatus may further include an input device. For example, the at least one instruction may, when executed by the controller, cause the vehicle control apparatus to identify that the specified event occurs, f receiving a user input associated with the air conditioning function for the specified seat, via the input device.

According to an example, the at least one instruction may, when executed by the controller, cause the vehicle control apparatus to turn off the air conditioning function for the specified seat if a specified time elapses, if the specified seat includes a child seat.

According to an example, the at least one instruction may, when executed by the controller, cause the vehicle control apparatus to monitor the duration of the no sitting state, if identifying the no sitting state for the specified seat using the sensor device, after it is identified that the user is sitting, and turn off the air conditioning function for the specified seat, if the duration is greater than a threshold.

According to an example, the at least one instruction may, when executed by the controller, cause the vehicle control apparatus to monitor the speed of the host vehicle, if identifying the no sitting state for the specified seat using the sensor device, after it is identified that the user is sitting, and turn off the air conditioning function for the specified seat, if the speed of the host vehicle is greater than a threshold speed.

According to an example, the at least one instruction may, when executed by the controller, cause the vehicle control apparatus to identify a state of the door corresponding to the specified seat, if identifying the no sitting state for the specified seat using the sensor device, after it is identified that the user is sitting, monitor the duration of the no sitting state, if identifying that the door is closed and then opened, and turn off the air conditioning function for the specified seat, if the duration is greater than a threshold.

According to an example, the at least one instruction may, when executed by the controller, cause the vehicle control apparatus to identify a state of the door corresponding to the specified seat, if identifying the no sitting state for the specified seat using the sensor device, after it is identified that the user is sitting, identify the speed of the host vehicle, if identifying the door is closed and then opened, and turn off the air conditioning function for the specified seat, if the speed of the host vehicle is greater than a threshold speed.

According to an example, the air conditioning function may include a heating wire function for the specified seat and a ventilation function for the specified seat.

According to an example, the at least one instruction may, when executed by the controller, cause the vehicle control apparatus to maintain the air conditioning function based on minimum operable intensity, if identifying that the specified event occurs again within a threshold time in a situation in which the no sitting state is identified, after it is identified that the user is sitting.

According to an example, the at least one instruction may, when executed by the controller, cause the vehicle control apparatus to maintain the air conditioning function based on minimum operable intensity, if the no sitting state and a state in which the host vehicle is being stopped are identified, after it is identified that the user is sitting.

According to another example of the present disclosure, a vehicle control method may include turning on, by a controller, an air conditioning function for a specified seat using an air conditioning device, if identifying that a specified event occurs, identifying, by the controller, whether a user is sitting on the specified seat, using a sensor device, and determining, by the controller, whether to turn off the air conditioning function, based on at least one of a type of the specified seat, whether a no sitting state of the user is identified, a duration of the no sitting state, a speed of a host vehicle, or whether a door corresponding to the specified seat is open, or any combination thereof, if it is identified that the user is sitting.

According to an example, the vehicle control method may further include identifying, by the controller, that the specified event occurs, if receiving a user input associated with the air conditioning function for the specified seat, via an input device.

According to an example, the vehicle control method may further include turning off, by the controller, the air conditioning function for the specified seat if a specified time elapses, if the specified seat includes a child seat.

According to an example, the vehicle control method may further include monitoring, by the controller, the duration of the no sitting state, if identifying the no sitting state for the specified seat using the sensor device, after it is identified that the user is sitting, and turning off, by the controller, the air conditioning function for the specified seat, if the duration is greater than a threshold.

According to an example, the vehicle control method may further include monitoring, by the controller, the speed of the host vehicle, if identifying the no sitting state for the specified seat using the sensor device, after it is identified that the user is sitting, and turning off, by the controller, the air conditioning function for the specified seat, if the speed of the host vehicle is greater than a threshold speed.

According to an example, the vehicle control method may further include identifying, by the controller, a state of the door corresponding to the specified seat, if identifying the no sitting state for the specified seat using the sensor device, after it is identified that the user is sitting, monitoring, by the controller, the duration of the no sitting state, if identifying that the door is closed and then opened, and turning off, by the controller, the air conditioning function for the specified seat, if the duration is greater than a threshold.

According to an example, the vehicle control method may further include identifying, by the controller, a state of the door corresponding to the specified seat, if identifying the no sitting state for the specified seat using the sensor device, after it is identified that the user is sitting, identifying, by the controller, the speed of the host vehicle, if identifying that the door is closed and then opened, and turning off, by the controller, the air conditioning function for the specified seat, if the speed of the host vehicle is greater than a threshold speed.

According to an example, the air conditioning function may include a heating wire function for the specified seat and a ventilation function for the specified seat.

According to an example, the vehicle control method may further include maintaining, by the controller, the air conditioning function based on minimum operable intensity, if identifying that the specified event occurs again within a threshold time in a situation in which the no sitting state is identified, after it is identified that the user is sitting.

According to an example, the vehicle control method may further include maintaining, by the controller, the air conditioning function based on minimum operable intensity, if the no sitting state and a state in which the host vehicle is being stopped are identified, after it is identified that the user is sitting.

According to another example of the present disclosure, a computer-readable storage medium may include a program for executing a vehicle control method including turning on, by a controller, an air conditioning function for a specified seat using an air conditioning device, if identifying that a specified event occurs, identifying, by the controller, whether a user is sitting on the specified seat, using a sensor device, and determining, by the controller, whether to turn off the air conditioning function, based on at least one of a type of the specified seat, whether a no sitting state of the user is identified, a duration of the no sitting state, a speed of a host vehicle, or whether a door corresponding to the specified seat is open, or any combination thereof, if it is identified that the user is sitting.

A description will be given of effects of the vehicle control apparatus and the method thereof according to an example of the present disclosure.

Examples of the present disclosure may adaptively terminate an air conditioning function which is being performed, if a situation in which it is okay even if the air conditioning function is terminated is identified, in the process in which the vehicle control apparatus performs the air conditioning function for a specified seat, thus preventing unnecessary power consumption.

Examples of the present disclosure may first operate operation intensity of the air conditioning function as minimum intensity, if a user input about the air conditioning function is received in a situation in which the user is not sitting on the seat, thus providing an efficient air conditioning function at the same time as matching the intention of the user (e.g., the intention of the user to activate the air conditioning function in advance before the user rides).

Examples of the present disclosure may adaptively turn off the air conditioning function depending on whether a specified condition is met, in a situation in which it is difficult for the user to control whether to operate the air conditioning function for the specified seat (e.g., a situation in which it is difficult for the user to access the input device).

Examples of the present disclosure may automatically turn off the air conditioning function in a situation in which the air conditioning function does not need to operate, thus minimizing unnecessary operation noise and providing the user with a pleasant indoor environment.

In addition, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus for controlling a vehicle, the apparatus comprising:
a sensor;
an air conditioner;
a memory storing at least one instruction; and
a processor operatively coupled to the sensor, the air conditioner, and the memory,
wherein the at least one instruction is configured to, when executed by the processor, cause the apparatus to:
turn on, based on an occurrence of a specified event, an air conditioning function, of the air conditioner, for a specified seat;
determine, based on sensor information from the sensor, whether a user is sitting on the specified seat; and
determine, based on a determination that the user is sitting on the specified seat, whether to turn off the air conditioning function, based on at least one of:
a type of the specified seat,
whether a no sitting state of the user is determined,
a duration of the no sitting state,
a speed of the vehicle, or
whether a door corresponding to the specified seat is open, or any combination thereof.

2. The apparatus of claim 1, further comprising:
a user interface configured to receive at least one user input,
wherein the at least one instruction is configured to, when executed by the processor, cause the apparatus to:
based on receiving, via the user input, a user input associated with the air conditioning function for the specified seat, determine that the specified event occurs.

3. The apparatus of claim 1, wherein the at least one instruction is configured to, when executed by the processor, cause the apparatus to:
turn off, based on elapsing of a specified time and the specified seat comprising a child seat, the air conditioning function for the specified seat.

4. The apparatus of claim 1, wherein the at least one instruction is configured to, when executed by the processor, cause the apparatus to:
after the determination that the user is sitting on the specified seat:
determine, based on sensor information from the sensor, a state of the user as the no sitting state, wherein the no sitting state indicates that the user is not sitting on the specified seat;
monitor the duration of the no sitting state; and
turn off, based on the duration satisfying a threshold, the air conditioning function for the specified seat.

5. The apparatus of claim 1, wherein the at least one instruction is configured to, when executed by the processor, cause the apparatus to:
after the determination that the user is sitting on the specified seat:
determine, based on sensor information from the sensor, a state of the user as the no sitting state, wherein the no sitting state indicates that the user is not sitting on the specified seat;
monitor, based on the determination of the no sitting state, the speed of the vehicle; and
turn off, based on the speed of the vehicle satisfying a threshold speed, the air conditioning function for the specified seat.

6. The apparatus of claim 1, wherein the at least one instruction is configured to, when executed by the processor, cause the apparatus to:
after the determination that the user is sitting on the specified seat:
determine, based on sensor information from the sensor, a state of the user as the no sitting state, wherein the no sitting state indicates that the user is not sitting on the specified seat;
monitor, based on the determination of the no sitting state and the door corresponding to the specified seat being closed and then opened, the duration of the no sitting state; and
turn off, based on the duration satisfying a threshold, the air conditioning function for the specified seat.

7. The apparatus of claim 1, wherein the at least one instruction is configured to, when executed by the processor, cause the apparatus to:
after the determination that the user is sitting on the specified seat:
determine, based on sensor information from the sensor, a state of the user as the no sitting state, wherein the no sitting state indicates that the user is not sitting on the specified seat;
determine, based on the determination of the no sitting state and the door corresponding to the specified seat being closed and then opened, the speed of the vehicle; and
turn off, based on the speed of the vehicle satisfying a threshold speed, the air conditioning function for the specified seat.

8. The apparatus of claim 1, wherein the air conditioning function comprises:
a heating wire function for the specified seat; and
a ventilation function for the specified seat.

9. The apparatus of claim 1, wherein the at least one instruction is configured to, when executed by the processor, cause the apparatus to:
after the determination that the user is sitting on the specified seat:
determine a state of the user as the no sitting state, wherein the no sitting state indicates that the user is not sitting on the specified seat; and
maintain, based on the determination of the no sitting state and a reoccurrence of the specified event within a threshold time, the air conditioning function, wherein the air conditioning function is maintained based on a minimum operable intensity.

10. The apparatus of claim 1, wherein the at least one instruction is configured to, when executed by the processor, cause the apparatus to:
after the determination that the user is sitting on the specified seat:
determine a state of the user as the no sitting state and that the vehicle is stopped, wherein the no sitting state indicates that the user is not sitting on the specified seat; and
maintain, based on the determination of the no sitting state and the vehicle being stopped, the air conditioning function, wherein the air conditioning function is maintained based on a minimum operable intensity.

11. A method performed by an apparatus for controlling a vehicle, the method comprising:
turning on, based on an occurrence of a specified event, an air conditioning function, of an air conditioner, for a specified seat;
determining, based on sensor information from a sensor, whether a user is sitting on the specified seat; and
determining, based on a determination that the user is sitting on the specified seat, whether to turn off the air conditioning function, based on at least one of:
a type of the specified seat,
whether a no sitting state of the user is determined,
a duration of the no sitting state,
a speed of the vehicle, or
whether a door corresponding to the specified seat is open, or any combination thereof.

12. The method of claim 11, further comprising:
based on receiving, via a user interface of the apparatus, a user input associated with the air conditioning function for the specified seat, determining that the specified event occurs.

13. The method of claim 11, further comprising:
turning off, based on elapsing of a specified time and the specified seat comprising a child seat, the air conditioning function for the specified seat.

14. The method of claim 11, further comprising:
after the determination that the user is sitting on the specified seat:
determining, based on sensor information from the sensor, a state of the user as the no sitting state, wherein the no sitting state indicates that the user is not sitting on the specified seat;
monitoring the duration of the no sitting state; and
turning off, based on the duration satisfying a threshold, the air conditioning function for the specified seat.

15. The method of claim 11, further comprising:
after the determination that the user is sitting on the specified seat:
determining, based on sensor information from the sensor, a state of the user as the no sitting state, wherein the no sitting state indicates that the user is not sitting on the specified seat;
monitoring, based on the determining the no sitting state, the speed of the vehicle; and
turning off, based on the speed of the vehicle satisfying a threshold speed, the air conditioning function for the specified seat.

16. The method of claim 11, further comprising:
after the determination that the user is sitting on the specified seat:
determining, based on sensor information from the sensor, a state of the user as the no sitting state, wherein the no sitting state indicates that the user is not sitting on the specified seat;
monitoring, based on the determining the no sitting state and the door corresponding to the specified seat being closed and then opened, the duration of the no sitting state; and
turning off, based on the duration satisfying a threshold, the air conditioning function for the specified seat.

17. The method of claim 11, further comprising:
after the determination that the user is sitting on the specified seat:
determining, based on sensor information from the sensor, a state of the user as the no sitting state, wherein the no sitting state indicates that the user is not sitting on the specified seat;
determining, based on the determining the no sitting state and the door corresponding to the specified seat being closed and then opened, the speed of the vehicle; and
turning off, based on the speed of the vehicle satisfying a threshold speed, the air conditioning function for the specified seat.

18. The method of claim 11, wherein the air conditioning function comprises:
a heating wire function for the specified seat; and
a ventilation function for the specified seat.

19. The method of claim 11, further comprising:
after the determination that the user is sitting on the specified seat:
determining a state of the user as the no sitting state, wherein the no sitting state indicates that the user is not sitting on the specified seat; and
maintaining, based on the determining the no sitting state and a reoccurrence of the specified event within a threshold time, the air conditioning function, wherein the air conditioning function is maintained based on a minimum operable intensity.

20. The method of claim 11, further comprising:
after the determination that the user is sitting on the specified seat:
determining a state of the user as the no sitting state and that the vehicle is stopped, wherein the no sitting state indicates that the user is not sitting on the specified seat; and
maintaining, based on the determining the no sitting state and the vehicle being stopped, the air conditioning function, wherein the air conditioning function is maintained based on a minimum operable intensity.
